(19) United States
(12) Patent Application Publication
(10) Pub. No.: US 2025/0058199 A1
(43) Pub. Date: Feb. 20, 2025

(54) INTER-ARCH COMPONENT (IAC), USE OF SUCH AN IAC, AND METHOD FOR PRODUCING AN INTRAORAL PROTECTOR (IOP) WITH SUCH AN IAC

(71) Applicants: UNIVERSITE DE BORDEAUX, BORDEAUX (FR); CENTRE HOSPITALIER UNIVERSITAIRE DE BORDEAUX, TALENCE CEDEX (FR)

(72) Inventor: Philippe POISSON, Saint-Seurin-sur-l'Isle (FR)

(21) Appl. No.: 18/720,526

(22) PCT Filed: Dec. 16, 2022
(86) PCT No.: PCT/FR2022/052392

§ 371 Date: Jun. 17, 2024

(30) Foreign Application Priority Data
Dec. 17, 2021 (FR) FR2113793

(51) Int. Cl. A63B 71/08; A61C 9/00; A61C 19/04

(52) U.S. Cl. CPC A63B 71/085; A61C 9/00; A61C 19/04

(57) ABSTRACT

The invention relates to an inter-arch component comprising a body (10) which has a U-shaped plate (11). the plate (11) having an upper face (11c) configured to bear against an upper dental arch of a wearer, and a lower face (11d) configured to be oriented towards a lower dental arch of the wearer, and the body (10) additionally having a graduated rule (17) which extends transversely to the plate (11) and which is configured to measure a distance between the upper dental arch and the lower dental arch. It also relates to a use of such an inter-arch component and to a method for producing an intraoral protector (IOP) having such an inter-arch component.

The invention relates to an inter-arch component (IAC) for digitised impression capture.

It relates to a general field of intraoral equipment, in particular in the sports field, for example for the prevention of oral trauma using an intraoral protector (IOP) or in the medical field, for example for the treatment of an occlusal disorder using an orthosis.

An intraoral protector (IOP) is an personal protective equipment (PPE) which allows keeping an accurate and easily reproducible functional mandibular position in order to provide the sportsman, regardless of his/her dento-maxillo-facial typology, with a ventilation ability when he/she exercises while having his/her jaws clenched.

An IOP is a device which appeared in the years 1890 in England and was intended, at the origin, to protect practitioners of English boxing from lip cuts caused by their sporting activity.

The IOP has evolved to become primarily a protection of the oral and maxillary structures, and then its role has extended to the prevention of brain concussions and cervical traumas when practicing risky sports.

Hence, an IOP has, inter alia, the function of:
reducing the risk of lesion of soft tissues (the tongue, the lips and the cheeks);
reducing the risk of lesion of the maxillary anterior teeth;
reducing the risk of oral lesion by violent inter-arch impact;
reducing the risk of cerebral concussion; or
reducing the risk of cervical damage.

In addition, an IOP has, inter alia, as properties:
to occupy the edentulous spaces;
to enable meshing of the lower and upper dental arches;
to be comfortable;
to have no protrusion or roughness;
to be retentive;
to absorb and dissipate the impact energy;
to enable phonation;
to enable oral ventilation with the jaws clenched.

By “retaining”, it should be understood the ability of the IOP to remain in place when the user opens the mouth.

By “meshing”, it should be understood the penetration of the antagonistic teeth into the occlusal bead of the gutter of the IOP to obtain locking of the lower and upper arches.

By “phonation”, it should be understood the ability of the user to express himself/herself orally.

Three IOP types are currently commonly proposed:
Type I: standard, uni- or bi-maxillary model. This consists of a ready-to-use IOP. However, such an IOP has the drawbacks of not enabling meshing of the lower and upper dental arches, of hindering the ventilation of sportsmen, of not being retentive, with the risk that the protection slips off during effort and that it becomes stuck in the airways of sportsmen.
Type II: adaptable, uni- or bi-maxillary model, this consists of an IOP that could be shaped in the mouth of the user, for example after softening the material that makes it up. However, such an IOP may have the drawback of losing up to 99% of thickness upon adaptation in the mouth, which limits the absorption and dissipation of the impact energy, and/or limits buccal ventilation with the jaws clenched.
Type III: tailored model. This consists of an IOP made after taking impressions, under the responsibility of a dental surgeon, of the lower and upper dental arches of the user. The (tailored) preparation mode should enable making of a high-quality IOP in accordance with the essential health and safety requirements recognised for such an EPI. However, depending on the operators, some of these type III IOPs may have a lower quality than type II models in terms of material thickness and ventilation ability with the jaws clenched. Hence, such IOPs might induce a reduced ventilation with the jaws clenched and during a dynamic activity, cause a hypoxia, with an alteration of the performance, or cause an oral opening to intended compensate for the ventilatory deficiency with an exacerbated risk of mandibular trauma. Finally, the mandibular meshing position may also be defined randomly, without taking account of the physiological oral opening of each individual.

Hence, an IOP should allow a satisfactory ventilation, as best as possible, with the jaws clenched, while ensuring stability of the positioning of the mandible.

For these purposes, it is therefore interesting to be able to manufacture a tailored IOP, in particular thanks to an at least partially digitised method.

For this purpose, such a method includes for example a step of recording, for example by an intraoral camera, the upper dental arch, the lower dental arch and, finally, the meshing position between these two arches. However, the meshing position imposes a substantial increase in the vertical dimension to build a tailored IOP with arrangement of a ventilatory space and, thus, be compliant with the current scientific data, for example with the Afnor XP S72-427 standard. This increase in the vertical dimension creates technical constraints for a digitised recording, in particular for example because it might induce an unstable and non-reproducible mandibular-maxillary meshing position, and/or a technical impossibility of scanning a free space between the two arches.

The invention aims to overcome these drawbacks, at least in part, while also being able to lead to other advantages.

Hence, to this end, according to a first aspect of the invention, an inter-arch part (IAC) is provided, comprising a body that comprises a U-shaped plate, the plate including an upper face configured to bear against an upper dental arch of a wearer, and a lower face configured to be oriented towards a lower dental arch of the wearer, and the body further comprising a graduated ruler which extends transversely to the plate and which is configured to measure a spacing between the upper dental arch and the lower dental arch.

An IAC refers to a means for measuring a distance between the free edges of the antagonistic maxillary and mandibular incisors of the jaws of a wearer.

The measurement allows fixing and reproducing three degrees of freedom (rotation, translation and diduction) of a mandibular position, necessary to form, in an intraoral protector (IOP) to be manufactured, a ventilatory space of a subject with the jaws clenched, based on one single measurement which could be made directly thanks to the IAC, in particular herein thanks to the graduated ruler.

Thus, such an inter-arch h component (IAC) enables wedging of the jaws, in particular positioning of the lower with respect to the upper arch, while remaining arch compatible with a digitised impression capture of meshing of the upper and lower arches, in particular an optical impression capture, for example using an intraoral camera.

The IAC also offers one single bite plate for the lower dental arch and the upper dental arch.

Hence, the plate is bitten, at least at some locations, between the upper dental arch and the lower dental arch of the wearer.

For example, the lower face is configured to bear against at least one portion of the lower dental arch of the wearer.

The IAC also comprises a mandibular portion, i.e. the graduated ruler, configured to determine a height of a free space to be left between the arches to form a desired ventilatory space in intraoral protector to be manufactured.

For example, this graduated ruler is formed in one-piece with the body of the IAC. Optionally, the IAC may include a posterior vestibular flap, for example a maxillary posterior vestibular flap and/or a mandibular posterior vestibular flap, configured to reinforce stability of the IAC while enabling a digitised impression capture. Indeed, in technic terms, the digitised impression capture of meshing of the maxillary and mandibular arches could concern only one to two vestibular face(s) of lateral antagonistic teeth. It is not necessary to have access to all of the vestibular faces of the lateral antagonistic teeth. Hence, such a maxillary and/or mandibular posterior vestibular flap is for example configured to allow access to vestibular faces of two or three lateral antagonistic teeth.

For example, the graduated ruler includes at least one graduation configured to position the lower dental arch according to a determined opening with respect to the upper dental arch.

For example, the graduated ruler extends from the lower face of the plate.

For example, the graduated ruler includes two pillars defining an aperture therebetween.

According to one embodiment, the body further includes an anterior rim configured to wedge at least one maxillary incisor of the wearer, the anterior rim extending transversely to the plate from the upper face.

According to one embodiment, the body includes a handling tab.

For example, the handling tab extends in an extension of the plate.

For example, the tab has a thickness substantially equal to a thickness of the plate.

For example, the tab includes a root by which it is connected to the plate.

For example, the tab includes a free end, opposite to its root.

For example, the free end and the root of the tab define a length of the tab therebetween.

Thus, the thickness of the tab is a dimension considered orthogonally to its length.

For example, the tab has a width, measured orthogonally to its thickness and its length.

For example, a width of the tab considered at its free end is smaller than a width of the tab considered at its root.

For example, the tab has a partial ellipse shape.

According to one embodiment, the inter-arch component comprises at least one bead covering at least one portion of the body.

For example, the body further includes a retention gutter configured to promote anchorage of the bead onto the body.

According to one embodiment, the body further includes a mandibular lingual flap, the mandibular lingual flap extending from the lower face of the plate.

According to one embodiment, at least one portion of the body includes perforations.

According to one embodiment, the body further includes at least one mandibular anterior wedge configured to form a stop for at least one incisor of the lower dental arch of the wearer.

Such a wedge also allows to better ensure a minimum spacing between the maxillary and mandibular incisors of a wearer, and consequently a sufficient ventilatory space.

For example, the mandibular anterior wedge extends from the lower face of the plate. For example, the wedge is centred with respect to the graduated scale.

For example, the wedge has a constant height with respect to the lower face of the plate. For example, the height of the wedge is comprised between 1 mm and 8 mm, for example about 2 mm or 4 mm.

According to a second aspect, the invention also relates to a use of an inter-arch component, including all or part of the previously-described features, to position and wedge the mandibular arch with respect to the upper arch of the wearer and take an intraoral impression.

Finally, according to a third aspect, the invention relates to a method for manufacturing an intraoral protector (IOP) with the inter-arch component (IAC) including all or part of the previously-described features.

For example, the method includes at least:
a step of placing the IAC in the mouth of the wearer, the upper face of the plate abutting against the upper dental arch of the wearer;
a step of placing the lower dental arch with respect to the upper dental arch at a desired spacing;
a step of reading a measurement of the spacing between the upper dental arch and the lower dental arch of the wearer according to the graduated ruler; and
a step of taking an intraoral impression of meshing of vestibular faces of maxillary and mandibular lateral teeth.

In one example of implementation, the step of placing the IAC in the mouth of the wearer includes a step of abutting at least one maxillary incisor of the wearer against the anterior rim of the body.

In one example of implementation, the step of taking an intraoral impression of meshing of vestibular faces of maxillary and mandibular lateral teeth comprises a step of intraoral recording of meshing of vestibular faces of maxillary and mandibular lateral teeth.

The invention, according to one embodiment, will be clearly understood and its advantages will appear better upon reading the following detailed description, given as an indication and without limitation, with reference to the appended drawings, wherein:

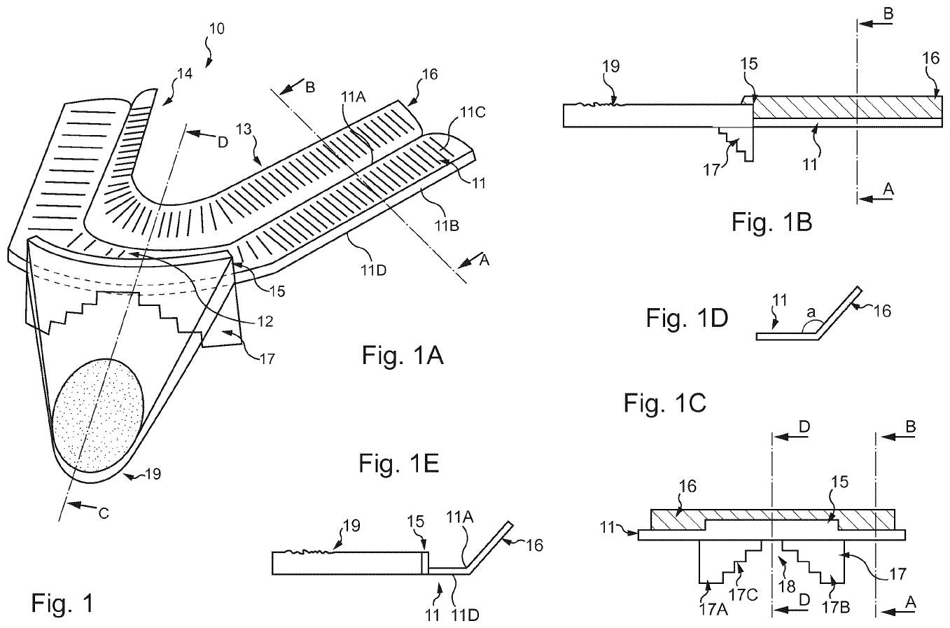

FIG. 1 shows the IAC according to a first embodiment;

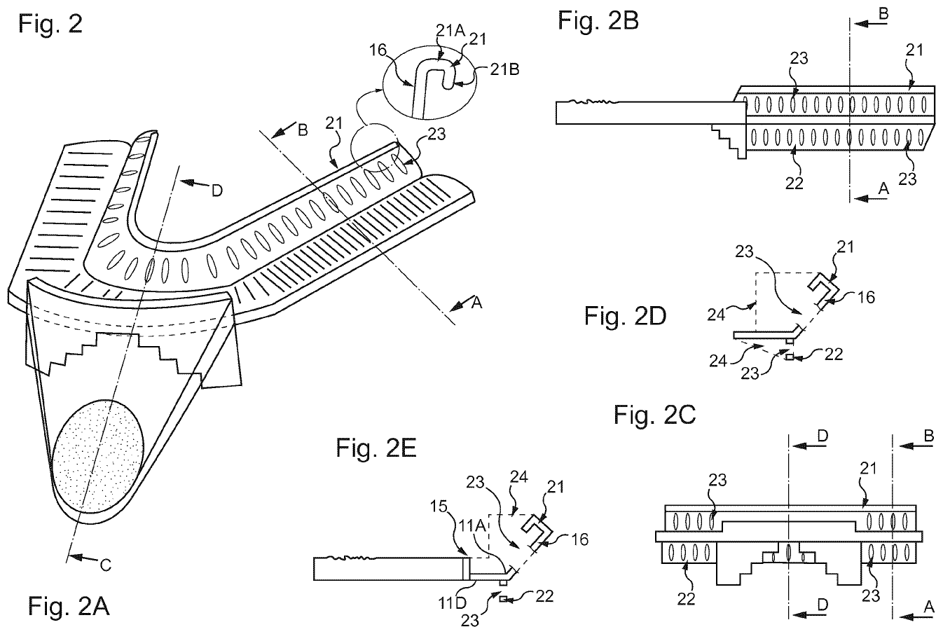

FIG. 2 shows the IAC according to a second embodiment;

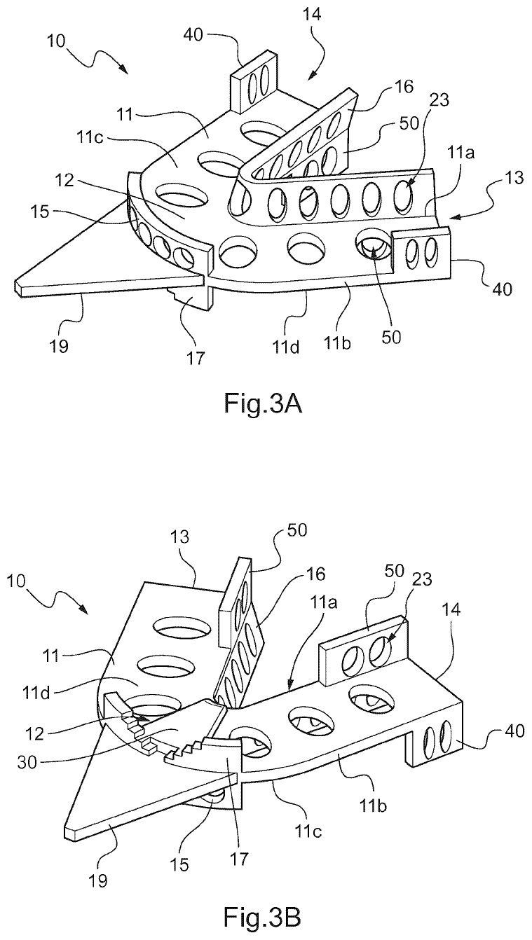

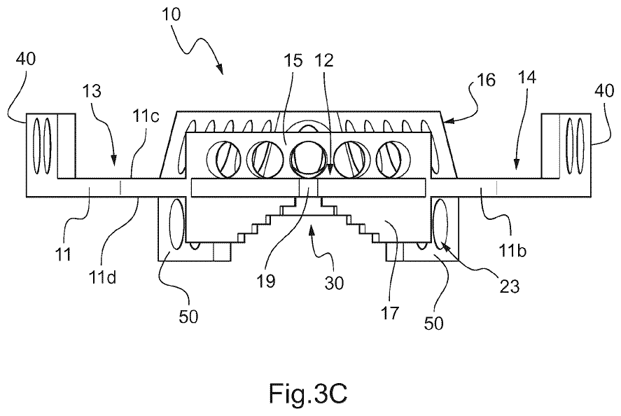

FIG. 3 shows the IAC according to a third embodiment; and

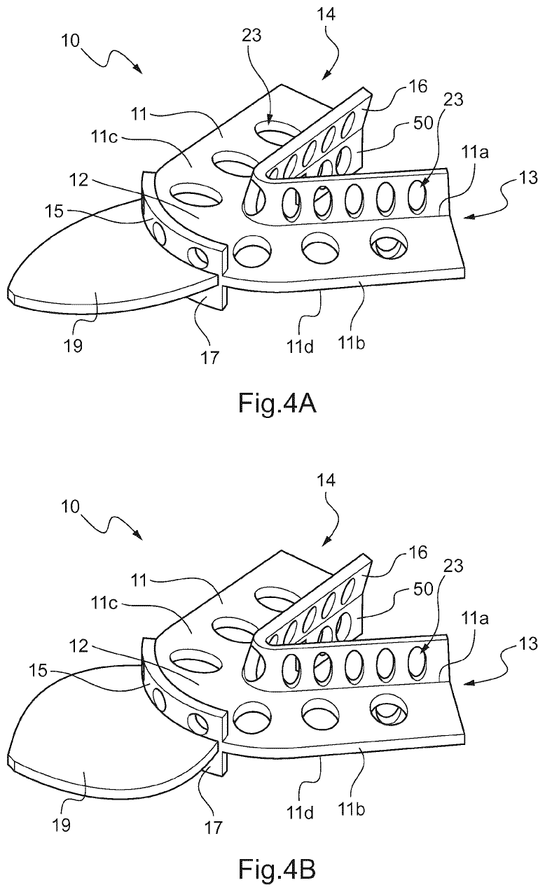

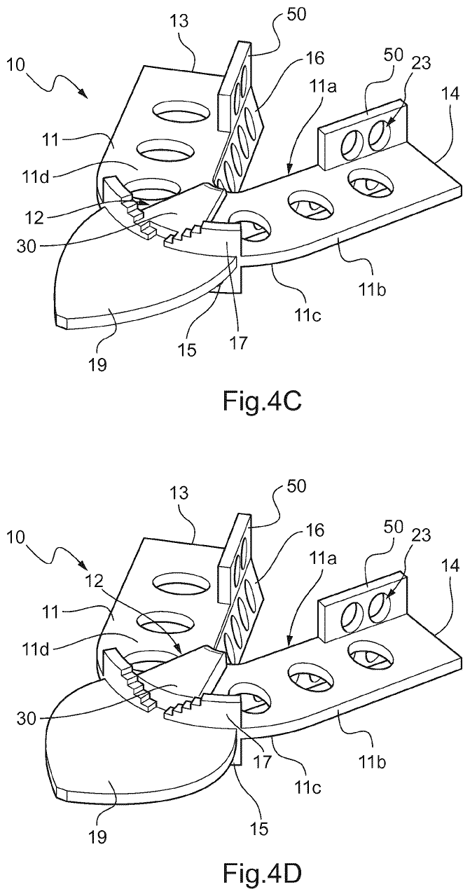

FIG. 4 shows the IAC according to a fourth embodiment.

The identical elements shown in the aforementioned figures are identified by identical reference numerals.

FIG. 1 shows an inter-arch component (IAC) according to a first embodiment.

In FIG. 1, FIG. 1A shows a perspective view of the IAC, FIG. 1B shows a profile view, FIG. 1C shows a front view, FIG. 1D shows a view according to the section A-B, and FIG. 1E shows a view according to the section C-D.

An IAC is configured to be placed in the mouth of a wearer who has an upper dental arch and a lower dental arch (not shown).

In particular, the IAC includes a body 10.

The body 10 primarily comprises a U-shaped plate 11. For this purpose, the plate 11 comprises an anterior portion 12, and two branches 13, 14 extending from the anterior portion 12.

The plate 11 is configured to be placed between the upper and lower dental arches of an individual, and to wedge the teeth of the upper dental arch.

Thus, the plate 11 is considered to be horizontal, and it serves herein as a reference plane.

By definition, the plate 11 includes an inner edge 11a and an outer edge 11b which delimit the U shape of the plate 11.

For example, both the inner edge 11a and the outer edge 11b have a U shape.

For example, the inner edge 11a may be parallel to the outer edge 11b.

In particular, the plate 11 may be flat and uniform.

For example, the plate 11 includes an upper face 11c configured to receive the upper dental arch, and a lower face 11d configured to optionally receive the lower dental arch.

For example, the lower face is parallel to the upper face.

For example, the “U”-shaped plate 11 has a constant thickness comprised between 1 mm and 5 mm, for example 2 mm. This thickness allows, on the one hand, preserving a minimum thickness between the occlusal faces of the last antagonistic molars, for example 2 mm, and, on the other hand, serving as a reference point to select the height of the ventilatory space measured vertically between the free edge of the maxillary and antagonistic mandibular incisors.

The body 10 herein further includes an anterior rim 15 configured to wedge at least one maxillary incisor of the wearer.

For example, the anterior rim 15 extends transversely to the plate 11 from the upper face 11c, and in particular from the anterior portion 12 of the plate 11.

Thus, the anterior rim 15 is herein considered to be vertical.

In particular, the anterior rim 15 is configured to abut the maxillary incisors of the wearer, which are housed, or blocked, by the plate 11 and the anterior rim 15.

The anterior rim 15 is herein formed by an arcuate wall according to a portion of the outer edge 11b of the anterior portion 12 of the plate 11, and in this case with constant thickness and height relative to the upper face 11c of the plate 11.

The body 10 herein further includes a maxillary lingual flap 16.

The maxillary lingual flap 16 herein extends from the inner edge 11a of the plate 11, and in particular all along the inner edge 11a of the plate 11.

For example, the maxillary lingual flap 16 herein has a U-shape too.

For example, it has the same thickness as the plate 11 so that it forms a continuity of the plate 11.

In particular, the maxillary lingual flap 16 is inclined with respect to the plate 11.

For example, the maxillary lingual flap 16 defines an angle “a” with the plate 11, and for example the angle “a” is comprised between about 90° and 180°, excluding 180°. For example, in the present embodiment, the angle “a” is about 120°.

In particular, such an inclination allows for a better adaptation of the IAC with a palate of the mouth of the wearer.

In particular, the body 10 also includes a graduated ruler 17.

The graduated ruler 17 is configured to measure a spacing between the upper dental arch and the lower dental arch of the wearer.

For example, ruler the graduated 17 extends transversely to the plate 11, in particular from the lower face 11d, and in particular herein from the anterior portion 12 of the plate 11.

Thus, the graduated ruler 17 is also herein considered as a vertical wall.

For this purpose, the graduated ruler 17 includes at least one graduation 17c configured to position the lower dental arch according to a determined opening with respect to the upper dental arch.

In the present embodiment, the graduation 17c includes a level, as described hereinbelow.

In the present embodiment, the graduated ruler 17 is formed of a wall that is arcuate according to a portion of the outer edge 11b of the front portion 12 of the plate 11.

In addition, the graduated ruler 17 herein includes an aperture 18, which is herein centred, in particular centred with respect to the vertical wall forming the graduated ruler 17, and more generally with respect to the body 10 of the IAC so as to be centred with respect to the incisors of the wearer.

Consequently, the graduated ruler 17 herein includes two pillars 17a, 17b which delimit the aperture 18 therebetween.

Furthermore, each pillar 17a, 17b herein includes at least one level forming a graduation 17c, and in particular herein several levels.

In such an embodiment wherein the graduated ruler 17 includes an aperture 18, the at least one graduation 17c is then preferably formed over an edge delimiting the aperture. Thus, at least one graduation 17c is herein formed on an edge of a first one of the two pillars 17a which faces an edge of a second one of the two pillars 17b. Furthermore, said edge of said second pillar 17b then preferably includes at least one graduation too.

Thus, the two edges of the pillars 17a, 17b which face each other herein have a staircase-like shape.

Finally, the body 10 includes a handling tab 19.

The handling tab 19 extends in an extension of the plate 11.

Such a handling tab 19 is intended to handle and position the IAC 10 in the mouth of the wearer.

For example, the body of the IAC is formed of a material, in particular made of a non-heat-mouldable material in the mouth.

In the embodiment of FIG. 1, the body 10 of the IAC is considered to be solid, i.e. free of perforations, as described hereinafter with reference to FIG. 2.

In the embodiment of FIG. 2, the IAC as shown in FIG. 1 further includes different possible options.

Like for FIG. 1, in FIG. 2, FIG. 2A shows a perspective view of the IAC, FIG. 2B shows a profile view, FIG. 2C shows a front view, FIG. 2D shows a view according to the section A-B, and FIG. 2E shows a view according to the section C-D

Although the IAC of FIG. 2 includes all of the options described herein, an IAC according to an embodiment of the invention may include only one of these options, or several ones of these options, according to any combinations therebetween.

Thus, in the example of FIG. 2, according to an interesting option, the body 10 of the IAC herein includes a bead 24 which wraps at least one portion of the body 10 of the IAC.

The bead 24 is herein schematised in FIGS. 2D and 2E only for simplicity.

The bead 24 is configured to reinforce holding of the IAC in position between the upper and lower arches.

It is further configured to adjust a spacing between the jaws to obtain a desired ventilatory space.

For example, the bead 24 is formed of an intraoral impression material.

For example, the intraoral impression material includes a silicone, or the like.

According to another example, the intraoral impression material may further include a heat-mouldable material, for example a copolymer of polyethylene and polyvinyl acetate, or the like, in particular if the bead wraps the upper and lower (maxillary and mandibular) faces of the body.

Where appropriate, a use of the IAC may involve, beforehand, softening the heat-mouldable material in a heated water, for example heated to boiling, then cooling it at least superficially, for example by soaking the IAC one to two seconds in a water at room temperature, or colder, before being placed in the mouth.

According to an interesting option, the IAC may further include an adhesive material, in particular applied over the body 10 of the IAC.

Such an adhesive material promotes holding of the bead 24 on the body 10 of the IAC.

In the present embodiment schematised in FIGS. 2D and 2E, the bead 24 includes an upper layer covering at least one portion of the upper face 11c of the plate and a lower layer covering at least one portion of the lower face 11d of the plate.

The upper and lower layers are herein illustrated very schematically, but they may have any profile type according to the needs and/or a jaw morphology.

According to another option, the body 10 may further include a retention gutter 21.

For example, the retention gutter 21 is configured to promote anchorage of the bead 24 onto the body of the IAC.

In particular, in FIG. 2, the retention gutter 21 includes two walls: a first wall 21a inclined with respect to the maxillary lingual flap 16, and a second wall 21b inclined with respect to the first wall 21a, the walls being inclined in the direction of the upper face 11c of the plate 11.

In FIG. 2, according to another interesting option, the body 10 further includes a mandibular lingual flap 22.

In the present embodiment, the mandibular lingual flap 22 extends from the lower face 11d of the plate 11, herein substantially orthogonally.

More particularly, the mandibular lingual flap 22 herein extends from the inner edge 11a of the plate 11.

Finally, in FIG. 2, according to yet another interesting option, the body 10 includes perforations 23.

Such a perforation is also configured to promote anchorage of the bead 24 on the body 10 of the IAC.

At least one of the perforations 23 herein has an oblong shape, but a perforation may have any shape type, for example round.

All perforations 23 herein have the same shape.

In one embodiment, at least the maxillary lingual flap 16 may include perforations 23, as shown herein.

In another possible example, also shown herein, complementarily or alternatively, the mandibular lingual flap 22 may also include perforations 23.

FIG. 3 shows an inter-arch component according to a third embodiment.

In FIG. 3, FIG. 3A shows in perspective a top view of the IAC, FIG. 3B shows in perspective a bottom view of the IAC, and FIG. 3C shows a front view of the IAC.

The IAC of the third embodiment differs from the IAC of the first embodiment in that the body 10 further includes at least one mandibular anterior wedge 30.

In particular, the mandibular anterior wedge 30 is configured to form a stop for at least one incisor of the lower dental arch of the wearer.

For example, such a wedge 30 allows to better ensure a minimum spacing between the maxillary and mandibular incisors of a wearer, and consequently a sufficient ventilatory space.

The at least one mandibular anterior wedge 30 extends from the lower face 11d of the plate 11, and in particular of the anterior portion 12.

In this case, the IAC herein includes one single mandibular anterior wedge 30 extending over the lower face 11d of the plate 11 with a constant height, for example about 2 mm, or 4 mm.

In this embodiment, the IAC further includes at least one flap from among a maxillary posterior vestibular flap 40 or a mandibular posterior vestibular flap 50.

The at least one maxillary posterior vestibular flap 40 and the at least one mandibular posterior vestibular flap 50 are configured to reinforce the stability of the IAC while allowing a digitised impression capture.

The at least one maxillary posterior vestibular flap 40 and the at least one mandibular posterior vestibular flap 50 are herein configured to clear access to vestibular faces of two or three lateral antagonistic teeth.

In this case, the IAC herein includes a maxillary posterior vestibular flap 40 and a mandibular posterior vestibular flap 50 on each of the two branches 13 and 14 of the U-shaped plate 11.

The two maxillary posterior vestibular flaps 40 herein extend transversely to the plate 11, from the upper face 11c, and in particular from the outer edge 11b.

The two mandibular posterior vestibular flaps 50 herein extend transversely to the plate 11, from the lower face 11d, and in particular from the inner edge 11a.

Finally, in FIG. 3, according to yet another interesting option, the body 10 includes perforations 23.

Of course, at least one amongst the mandibular anterior wedge 30, the maxillary posterior vestibular flap 40 or the mandibular posterior vestibular flap 50 may be combined with one of the embodiments of FIG. 1 or 2.

FIG. 4 shows a fourth embodiment of an inter-arch component according to two variants.

FIG. 4 includes, on the one hand, FIGS. 4A and 4B which show a top view of the two variants and, on the other hand, FIGS. 4C and 4D which show a bottom view of two variants.

The two illustrated variants differ from one another by the thickness of the mandibular anterior wedge 30.

In the present embodiment, the wedge 30 of a first one of the two variants (FIGS. 4A and 4C) herein has a thickness of 2 mm.

In the present embodiment, the wedge 30 of a second one of the two variants (FIGS. 4B and 4D) herein has a thickness of 4 mm.

Like for the previous examples, the tab 19 has a thickness substantially equal to a thickness of the plate.

The tab 19 includes a root through which it is connected to the plate.

The tab 19 includes a free end, opposite to its root.

The free end and the root of the tab 19 define a length of the tab therebetween.

The tab 19 has a width measured orthogonally to its thickness and its length. The width of the tab 19 considered at its free end is herein smaller than a width of the tab considered at its root.

On the other hand, the IAC of these two variants differs from the IAC of the third embodiment in particular by the shape of the tab 19.

The tab 19 herein has a partial ellipse shape.

In particular, the partial ellipse shape of the handling tab 19 allows for a better grasping, facilitating insertion and/or removal of the IAC from a mouth of an individual.

Furthermore, the IAC of these two variants does not include a maxillary posterior vestibular flap 40, but it includes a maxillary lingual flap 16 and a mandibular posterior vestibular flap 50.

In these figures, it should be noted that the body 10 includes perforations 23 like the embodiment of FIG. 3.

An IAC according to any one of the above-described embodiments is particularly interesting for taking an intraoral impression, in particular for taking an optical impression, for example by an intraoral camera, in order to make a tailored IOP.

For this purpose, a method for manufacturing an IOP with an IAC according to an example of implementation of the invention takes place, for example, as follows.

The IAC is placed in the mouth of a wearer, the upper face 11c of the plate 11 bearing on an upper dental arch of the wearer.

For example, the maxillary incisors bear against the anterior rim 15, and/or one end of the branches of the U are wedged at the bottom of the jaw in order to guarantee at least 2 mm of spacing between the occlusal faces of the last antagonistic molars.

Hence, the plate is bitten, at least at some locations, between the upper dental arch and the lower dental arch of the wearer.

If a bead 24 is present, at least partially on the upper face of the body 10, it facilitates holding of the IAC on the upper arch.

Afterwards, a lower dental arch of the wearer is positioned, for example according to a desired ventilatory space.

For example, the lower dental arch of the wearer is tightened, for example by biting the bead 24, in particular if at least one bead portion 24 is present on the lower face of the body 10, until incisors of the lower dental arch of the wearer align with a desired graduation 17c.

Afterwards, the method includes a step of reading a measurement of the spacing between the upper dental arch and the lower dental arch of the wearer according to the graduated ruler 17.

Afterwards, the method includes a step of taking an impression, for example by an intraoral scan, of a meshing of vestibular faces of maxillary and mandibular lateral teeth.

1. An inter-arch component comprising a body (10) which comprises a U-shaped plate (11), the plate (11) comprising an upper face (11c) configured to bear against an upper dental arch of a wearer, and a lower face (11d) configured to be oriented towards a lower dental arch of the wearer, and the body (10) further comprising a graduated ruler (17) which extends transversely to the plate (11), characterised in that the graduated ruler (17) extends from the lower face (11d) of the plate (11) and is configured to measure a spacing between the upper dental arch and the lower dental arch.

2. The inter-arch component according to claim 1, characterised in that the graduated ruler (17) comprises at least one graduation (17c) configured to position the lower dental arch according to a determined opening with respect to the upper dental arch.

3. The inter-arch component according to claim 1, characterised in that the graduated ruler (17) comprises two pillars (17a, 17b) defining an aperture (18) therebetween.

4. The inter-arch component according to claim 1, characterised in that the body (10) further comprises an anterior rim (15) configured to wedge at least one maxillary incisor of the wearer, the anterior rim (15) extending transversely to the plate (11) from the upper face (11c).

5. The inter-arch component according to claim 1, characterised in that the body (10) includes a handling tab (19).

6. The inter-arch component according to claim 5, characterised in that the handling tab (19) extends in an extension of the plate (11).

7. The inter-arch component according to claim 1, characterised in that it comprises at least one bead (24) covering at least one portion of the body (10).

8. The inter-arch component according to claim 7, characterised in that the body (10) further comprises a retention gutter (21) configured to promote anchorage of the bead (24) on the body (10).

9. The inter-arch component according to claim 1, characterised in that the body (10) further comprises a mandibular lingual flap (22), the mandibular lingual flap (22) extending from the lower face (11d) of the plate (11).

10. The inter-arch component according to claim 1, characterised in that at least one portion of the body (10) comprises perforations (23).

11. A use of an inter-arch component according to claim 1 for positioning and wedging the mandibular arch with respect to the maxillary arch of the wearer and taking an intraoral impression.

12. A method for manufacturing an intraoral protector (IOP) with the inter-arch component according claim 1, comprising at least:
a step of placing the IAC in the mouth of the wearer, the upper face (11c) of the plate (11) abutting against the upper dental arch of the wearer;
a step of placing the lower dental arch with respect to the upper dental arch at a desired spacing;
a step of reading a measurement of the spacing between the upper dental arch and the lower dental arch of the wearer according to the graduated ruler (17); and
a step of taking an intraoral impression of meshing of vestibular faces of maxillary and mandibular lateral teeth.

13. The method according to claim 12, wherein the step of placing the IAC in the mouth of the wearer comprises a step of abutting at least one maxillary incisor of the wearer against the anterior rim (15) of the body (10).
